(19) United States
(12) Patent Application Publication
(10) Pub. No.: US 2010/0247232 A1
(43) Pub. Date: Sep. 30, 2010

(54) TWO-SECTION TOOL JOINT

(76) Inventor: Hsiu-Nien Lin, Dali City (TW)

Correspondence Address: Dr. BANGER SHIA;Patent Office of Bang Shia, 102 Lindencrest Ct, Sugar Land, TX, 77479-5201, US

(21) Appl. No.: 12/413,582

(22) Filed: Mar. 29, 2009

(51) Int. Cl. F16C 11/06

(52) U.S. Cl. 403/76

(57) ABSTRACT

A two-section tool joint comprises a support member including a polygonal ball knob disposed on one end thereof; an acting head including a receiving chamber fixed on end thereof, and on a side wall of the receiving chamber being arranged a plurality of raised rims in response to the ball knob; a limiting structure defined between the support member and the acting head so that the ball knob of the support member is limited in the receiving chamber and moves between a first and a second positions; wherein the raised rims are longitudinally defined on a side wall of the receiving chamber and spaced apart equally from each other, the number of the raised rims is in response to that of the angles of the ball knob, and each raised rim is provided with a convex arc contacting surface so that the support member rotates with the acting head.

### BACKGROUND OF THE INVENTION

1. Field of the Invention

The present invention relates to a two-section tool joint.

2. Description of the Prior Art

The JP Publication No. P2004-237420 discloses that a tool joint includes a polygonal ball knob of a support member being received in a receiving chamber of an acting head, and a shape of the receiving chamber being in response to that of the ball knob to form a polygon shape. Besides, a connection structure is used to engage the acting head with the support member together, as the support member is pressed therein. And as the support member is pulled out, the support member swings pivotally relative to the acting head.

However, because an inner wall of the receiving chamber is formed in a polygon shape, the ball knob contacts with the inner wall of the receiving chamber surface by surface, and as an electronic driving device is turned on so that the acting head is driven to rotate at high speed by the support member, the ball knob and the receiving chamber rub against with each other severely to damage the electronic driving device and the tool joint.

The present invention has arisen to mitigate and/or obviate the afore-described disadvantages.

### SUMMARY OF THE INVENTION

The primary object of the present invention is to provide a two-section tool joint that can operate its acting head smoothly to enhance operational efficiency.

A two-section tool joint in accordance with the present invention comprises:

a support member including a polygonal ball knob disposed on one end thereof;

an acting head including a receiving chamber fixed on end thereof, and on a side wall of the receiving chamber being arranged a plurality of raised rims in response to the ball knob; and

a limiting structure defined between the support member and the acting head so that the ball knob of the support member is limited in the receiving chamber and moves between a first and a second positions;

wherein the raised rims are longitudinally defined on a side wall of the receiving chamber and are spaced apart equally from each other, the number of the raised rims is in response to that of the angles of the ball knob, and each raised rim is provided with a convex arc contacting surface so that the support member rotates with the acting head;

wherein as the support member is pressed toward the first position, the support member is assembled together with the acting head;

wherein as the support member is slightly pulled toward the second position, the support member can swing relative to the acting head by using the ball knob as its pivot point.

### BRIEF DESCRIPTION OF THE DRAWINGS

FIG. 1 is a perspective view showing the exploded components of a two-section tool joint in accordance with a first embodiment of the present invention;

FIG. 1A is a cross sectional view of a part of FIG. 1;

FIG. 2 is a perspective view showing the assembly of the two-section tool joint in accordance with the first embodiment of the present invention;

FIG. 3 is a partial cross sectional view showing the support member being located at a first position in accordance with the first embodiment of the present invention;

FIG. 4 is a partial cross sectional view showing the support member being located at a second position in accordance with the first embodiment of the present invention;

FIG. 5 is a partial cross sectional view showing the support member being located at the second position and becoming inclined in accordance with the first embodiment of the present invention;

FIG. 6 is a perspective view showing the exploded components of a two-section tool joint in accordance with a second embodiment of the present invention;

FIG. 7 is a perspective view showing the assembly of the two-section tool joint in accordance with the second embodiment of the present invention;

FIG. 8 is a partial cross sectional view showing the support member being located at a first position in accordance with the second embodiment of the present invention;

FIG. 9 is a partial cross sectional view showing the support member being located at a second position in accordance with the second embodiment of the present invention;

FIG. 10 is a partial cross sectional view showing the support member being located at the second position and becoming inclined in accordance with the second embodiment of the present invention;

FIG. 11 is a cross sectional view showing a largest diameter of a polygonal ball knob of the present invention;

FIG. 11A is an amplified view of a part of FIG. 11.

### DETAILED DESCRIPTION OF THE PREFERRED EMBODIMENTS

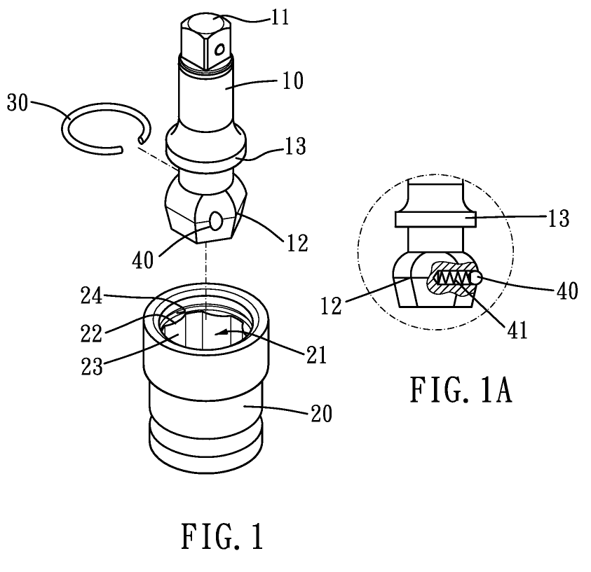

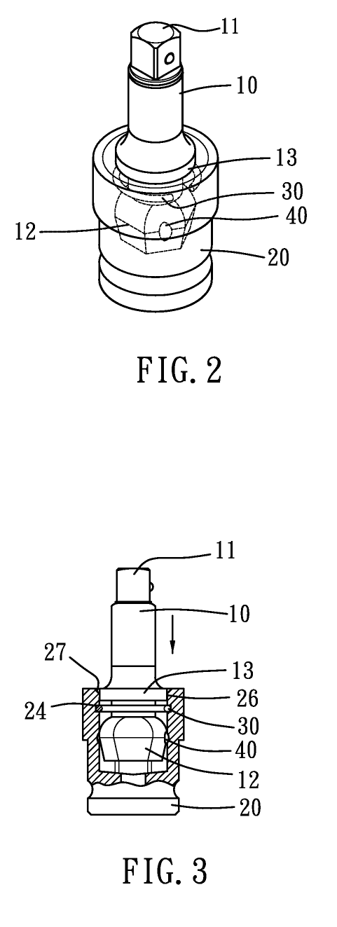

The present invention will be clearer from the following description when viewed together with the accompanying drawings, which show, for purpose of illustrations only, the preferred embodiment in accordance with the present invention. Referring to FIGS. 1, 1A, and 2, a two-section tool joint in accordance with the present invention comprises: a support member 10, an acting head 20, and a limiting structure 30; wherein

the support member 10 includes a polygonal ball knob 12 disposed on one end thereof and a driving portion 11 mounted on another end thereof, the driving portion 11 is provided to couple a driving device and used in electronic driving tools (such as an electronic screwdriver, an electronic drill) or in hand tools (such as an open-end wrench, a socket wrench, or a screwdriver);

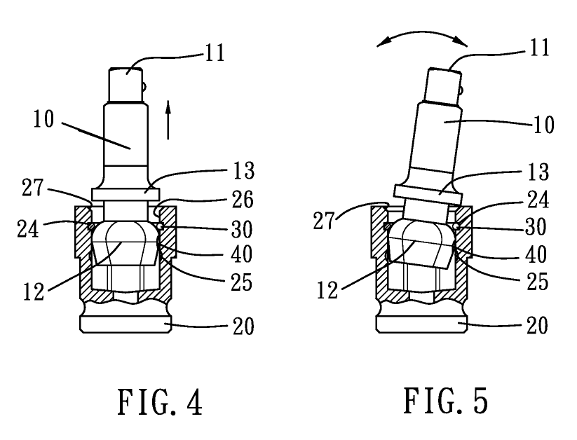

the acting head 20 includes a receiving chamber 21 fixed on end thereof, and another end of the acting head 20 is used to receive a tool, such as a socket, a screwdriver, various types of drills, etc., and on a side wall of the receiving chamber 21 are arranged a plurality of raised rims 22 in response to the ball knob 12. Specifically, the raised rims 22 are longitudinally defined on the side wall of the receiving chamber 21 and are spaced apart equally from each other, the number of the raised rims 22 is in response to that of the angles of the ball knob 12 (In this embodiment, the number of the angles is six,) and each raised rim 22 is provided with a convex arc contacting surface 23 to contact with the ball knob 12, hence the support member 10 can rotate with the acting head 20 randomly, wherein each of the contacting surfaces 23 includes a central axis (e.g., a central line of the contacting surface 23), and the central axes of the contacting surfaces 23 are parallel to each other, e.g., a distance between any two raised rims 22 is equal to facilitate working and assembling processes. Besides, the distance can be reduced or increased gradually. In the meantime, the central axes are not parallel to each other. At a suitable position of the receiving chamber 21 is arranged a limiting recess 25 (as shown in FIG. 4), the limiting recess 25 can be disposed in a spot arrangement or surrounds around the side wall of the receiving chamber 21. At a largest diameter of the ball knob 12 is radially mounted a receiving bore in which an engaging member 40 is fixed, between the receiving bore and the engaging member 40 is defined an resilient element 41, two ends of the resilient element 41 are abutted against the receiving bore and the engaging member 40 individually so that the engaging member 40 can move toward an opening of the receiving bore at any time.

Furthermore, the limiting structure 30 is defined between the support member 10 and the acting head 20 so that the ball knob 12 of the support member 10 is limited in the receiving chamber 21 and moves between a first and a second positions. It is preferable that the limiting structure 30 is a C-shaped retainer (as illustrated in FIG. 1) or a circular liner, the C-shaped retainer of the limiting structure 30 is mounted in an annular groove 24 of the receiving chamber 21, and the annular groove 24 is located above the raised rims 22.

The tool joint of the present invention can be used in a two-section manner. For example, as the support member 10 is located at the first position or the second position, different functions are achieved. Specifically, as the support member 10 is pressed toward the first position, the support member 10 is assembled together with the acting head 20 to prevent the support member 10 from shock. As the support member 10 is slightly pulled toward the second position, the support member 10 can swing relative to the acting head 20 by using the ball knob 12 as its pivot point, enabling to operate the tool joint in a limited space.

Referring to FIGS. 1-5, a two-section tool joint in accordance with a first embodiment of the present invention comprises a circular fringe 13 radially extending from the support member 10, and the receiving chamber 21 includes an annular abutting periphery 26 mounted on the opening thereof, a diameter of the circular fringe 13 is substantially equal to an inner diameter of the abutting periphery 26, thereby the fringe 13 can be engageably received in a space surrounded by the abutting periphery 26.

As shown in FIG. 3, as the support member 10 is located at the first position, the fringe 13 engages with the abutting periphery 26 so as to limit the shock of the support member 10. At that time, the engaging member 40 is defined in the limiting recess 25 to position the support member 10 at the first position.

With reference to FIGS. 4 and 5, as the support member 10 is slightly pulled toward the second position, the fringe 13 disengages from the abutting periphery 26, and because an outer surface of the ball knob 12 is formed in a curved surface shape, the support member 10 can swing in relation to the acting head 20 by using the ball knob 12. It is to be noted that although the support member 10 can swing with respect to the acting head 20 but not rotate with the acting head 20 so as to rotatably lock a locking element. Moreover, to swing the support member 10 more smoothly, on the opening of the receiving chamber 21 is provided a circular chamfer 27 which can be formed in an inclined surface or an actuated surface shape. Also, the engaging member 40 is located outside the limiting recess 25 and makes the support member 10 slant automatically.

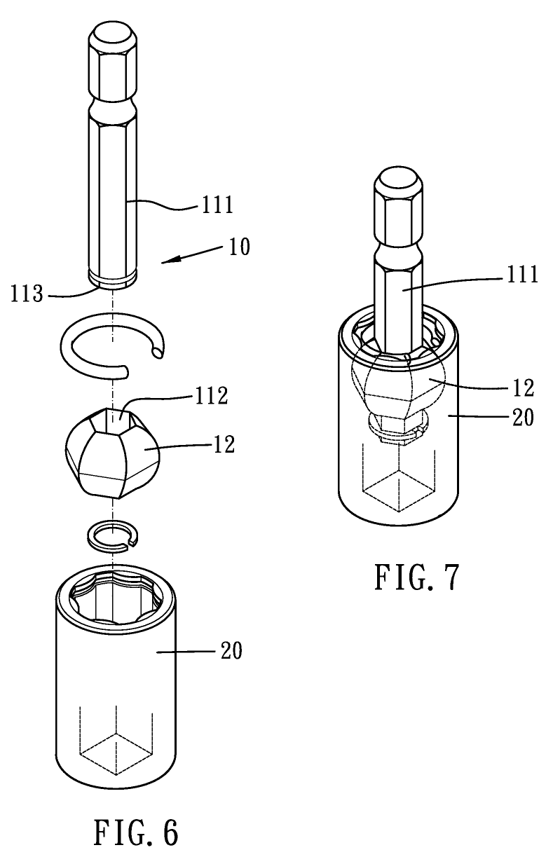

As shown in FIGS. 6-10, a tool joint according to a second embodiment of the present invention comprises a support member 10 having a shaft 111, a laterally cross section of which is formed in an noncircular shape, and the polygonal ball knob 12 including a centrally through hole 112, a shape of which is in response to a profile of the shaft 111 so that the shaft 111 can rotate with the ball knob 12. The shaft 111 includes a connecting end 113 which extends out of the through hole 112, and the acting head 20 further includes a coupling slot 211 in communication with the receiving chamber 21, and a shape of the coupling slot 211 corresponds to a profile of the connecting end 113.

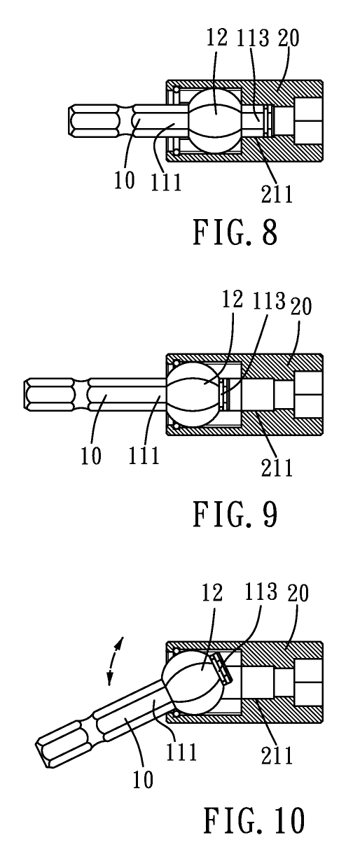

Thereby, as the support member 10 is located at the first position as illustrated in FIG. 8, the connecting end 113 is received in the coupling slot 211 so as to limit the support member 12 not to swing relative to the acting head 20, and the shaft 111, the ball knob 12, and the acting head 20 can rotate together.

Besides, as the support member 10 is located at the second position, the connecting end 113 disengages from the coupling slot 211 so that the support member 10 can swing with respect to the acting head 20.

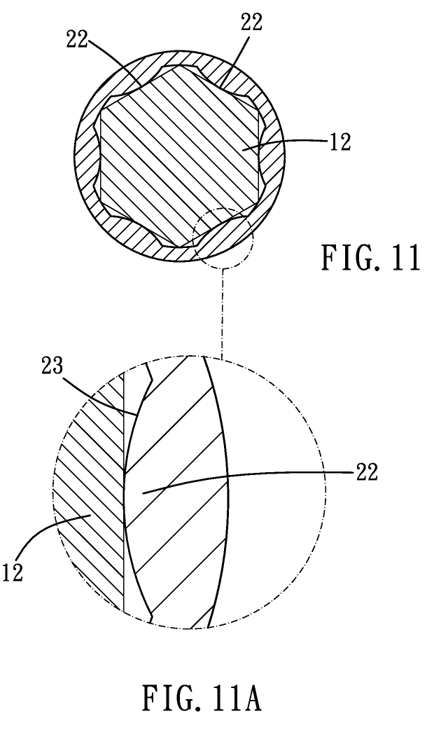

In the present invention, due to the raised rims 22 are fixed on the side wall of the receiving chamber 21, and each raised rim 22 is provided with a convex arc contacting surface 23, accordingly as shown in FIGS. 11 and 11A, the ball knob 12 contacts with the receiving chamber 21 point by point instead of surface by surface. Also, because the raised rims 22 are spaced apart equidistantly, a gap between the two raised rims 22 is generated to swing the ball knob 12, thus smoothly swinging the support member 10 in relation to the acting head 20. For clearly showing the present invention, the largest diameter of the ball knob 12 is drawn to equal to the distance between the two raised rims 22. However, it is preferable that the largest diameter of the ball knob 12 is slightly smaller than the distance between the two raised rims 22, swinging the support member 10 smoothly.

As illustrated in FIGS. 9 and 10, as the support member 10 is located at the second position, the connecting end 113 disengages from the coupling slot 211 so that the support member 10 can swing with respect to the acting head 20.

While we have shown and described various embodiments in accordance with the present invention, it is clear to those skilled in the art that further embodiments may be made without departing from the scope of the present invention.

What is claimed is:

1. A two-section tool joint comprising:
a support member including a polygonal ball knob disposed on one end thereof;
an acting head including a receiving chamber fixed on end thereof, and on a side wall of the receiving chamber being arranged a plurality of raised rims in response to the ball knob; and
a limiting structure defined between the support member and the acting head so that the ball knob of the support member is limited in the receiving chamber and moves between a first and a second positions;
wherein the raised rims are longitudinally defined on a side wall of the receiving chamber and spaced apart equally from each other, the number of the raised rims is in response to that of the angles of the ball knob, and each raised rim is provided with a convex arc contacting surface so that the support member rotates with the acting head;
wherein as the support member is pressed toward the first position, the support member is assembled together with the acting head;
wherein as the support member is slightly pulled toward the second position, the support member can swing relative to the acting head by using the ball knob as its pivot point.

2. The two-section tool joint as claimed in claim 1, wherein the limiting structure is a C-shaped retainer, the C-shaped retainer is mounted in an annular groove of the side wall of the receiving chamber, and the annular groove is located above the raised rims.

3. The two-section tool joint as claimed in claim 1, wherein a circular fringe extends on the support member, and the receiving chamber includes an annular abutting periphery mounted on an opening thereof, a diameter of the circular fringe is substantially equal to an inner diameter of the annular abutting periphery, thereby as the support member is located at the first position, the circular fringe engages with the annular abutting periphery, and as the support member is located at the second position, the circular fringe disengages from the annular abutting periphery.

4. The two-section tool joint as claimed in claim 1, wherein the support member includes a shaft, a laterally cross section of which is formed in an noncircular shape, and the polygonal ball knob includes a centrally through hole, a shape of which is in response to a profile of the shaft so that the shaft can rotate with the ball knob, and the shaft includes a connecting end which extends out of the through hole, and the acting head further includes a coupling slot in communication with the receiving chamber, and a shape of the coupling slot corresponds to a profile of the connecting end; as the support member is located at the first position, the connecting end is received in the coupling slot, and as the support member is located at the second position, the connecting end is located outside the coupling slot.

5. The two-section tool joint as claimed in claim 1, wherein on the opening of the receiving chamber is provided a circular chamfer.

6. The two-section tool joint as claimed in claim 1, wherein at a suitable position of the receiving chamber is arranged a limiting recess, and at a largest diameter of the ball knob is radially mounted a receiving bore in which an engaging member is fixed, between the receiving bore and the engaging member is defined an resilient element which is abutted against the receiving bore and the engaging member, wherein as the support member is located at the first position, the engaging member is engaged in the limiting recess, and as the support member is located at the second position, the engaging member is located outside the limiting recess.

7. The two-section tool joint as claimed in claim 2, wherein at a suitable position of the receiving chamber is arranged a limiting recess, and at a largest diameter of the ball knob is radially mounted a receiving bore in which an engaging member is fixed, between the receiving bore and the engaging member is defined an resilient element which is abutted against the receiving bore and the engaging member, wherein as the support member is located at the first position, the engaging member is engaged in the limiting recess, and as the support member is located at the second position, the engaging member is located outside the limiting recess.

8. The two-section tool joint as claimed in claim 3, wherein at a suitable position of the receiving chamber is arranged a limiting recess, and at a largest diameter of the ball knob is radially mounted a receiving bore in which an engaging member is fixed, between the receiving bore and the engaging member is defined an resilient element which is abutted against the receiving bore and the engaging member, wherein as the support member is located at the first position, the engaging member is engaged in the limiting recess, and as the support member is located at the second position, the engaging member is located outside the limiting recess.

9. The two-section tool joint as claimed in claim 4, wherein at a suitable position of the receiving chamber is arranged a limiting recess, and at a largest diameter of the ball knob is radially mounted a receiving bore in which an engaging member is fixed, between the receiving bore and the engaging member is defined an resilient element which is abutted against the receiving bore and the engaging member, wherein as the support member is located at the first position, the engaging member is engaged in the limiting recess, and as the support member is located at the second position, the engaging member is located outside the limiting recess.

10. The two-section tool joint as claimed in claim 5, wherein at a suitable position of the receiving chamber is arranged a limiting recess, and at a largest diameter of the ball knob is radially mounted a receiving bore in which an engaging member is fixed, between the receiving bore and the engaging member is defined an resilient element which is abutted against the receiving bore and the engaging member, wherein as the support member is located at the first position, the engaging member is engaged in the limiting recess, and as the support member is located at the second position, the engaging member is located outside the limiting recess.

11. The two-section tool joint as claimed in claim 1, wherein each of the contacting surfaces includes a central axis, and the central axes of the contacting surfaces are parallel to each other.

12. The two-section tool joint as claimed in claim 2, wherein each of the contacting surfaces includes a central axis, and the central axes of the contacting surfaces are parallel to each other.

13. The two-section tool joint as claimed in claim 3, wherein each of the contacting surfaces includes a central axis, and the central axes of the contacting surfaces are parallel to each other.

14. The two-section tool joint as claimed in claim 4, wherein each of the contacting surfaces includes a central axis, and the central axes of the contacting surfaces are parallel to each other.

15. The two-section tool joint as claimed in claim 5, wherein each of the contacting surfaces includes a central axis, and the central axes of the contacting surfaces are parallel to each other.
